(19) United States
(12) Patent Application Publication
(10) Pub. No.: US 2004/0003708 A1
(43) Pub. Date: Jan. 8, 2004

(54) Device and method for sensing positions and/or velocities of keys and pedals of a piano

(76) Inventor: Donald Frederick Buchla, Berkeley, CA (US)

Correspondence Address: Terry McHugh, Law Offices of Terry McHugh, 101 First Street - PMB 560, Los Altos, CA, 94022, US

(21) Appl. No.: 10/600,102

(22) Filed: Jun. 20, 2003

Related U.S. Application Data
(60) Provisional application No. 60/392,615, filed on Jun. 28, 2002.

(51) Int. Cl. G10H 3/06

(52) U.S. Cl. 84/724

(57) ABSTRACT

A device for use with a piano includes a housing configured to reside above a minor rearward portion of a keyboard of the piano and includes an array of signal generators mounted to the housing to monitor activities of the individual keys, without requiring any mechanical contact with the keys. Each signal generator is operatively associated with a single key and includes at least one light emitting device positioned to direct light so as to directly impinge the associated key when the key is in its rest position. In its preferred embodiment, the movement of each white key is monitored using light reflecting techniques, while the movement of each black key is monitored using light transmitting techniques. Piano pedal movement may also be monitored, but non-optical techniques may be employed.

### CROSS REFERENCE TO RELATED APPLICATION

This application claims priority from copending provisional application Serial No. 60/392,615, filed Jun. 28, 2002.

### TECHNICAL FIELD

The invention relates generally to add-on devices for pianos and more particularly to a device and method for non-intrusively expanding the capabilities of an acoustic piano.

### BACKGROUND ART

As compared to conventional acoustic pianos, electronic keyboards and synthesizers offer a number of performance advantages. As one example, an electronic keyboard may use a Musical Instrument Digital Interface (MIDI) which allows a keyboard to be connected to a computer or to other MIDI hardware that enables recording and sophisticated signal processing. An electronic keyboard may be placed in any of a variety of modes, so as to achieve certain sounds or blends of sounds. In a multi-timbral mode, different timbres can be audibilized simultaneously.

There have been attempts to combine the performance features of an electronic keyboard with a traditional acoustic piano. Many of the attempts require significant modification to the piano. U.S. Pat. No. 5,834,669 to Clift et al. describes an apparatus for determining musical note characteristics from the motion of hammer catchers. As is well known, the sounds of an acoustic piano are generated as a result of hammers striking strings. The Clift et al. patent states that measurements of the velocity and position of hammer catchers result in a high degree of accuracy in sensing musical expression. The Clift et al. apparatus includes optical emitters and sensors positioned above the hammer catchers. The optical emitters and sensors must be fitted within the interior of the piano, which may require significant alteration and installation expertise. This is also true of the apparatus of U.S. Pat. No. 6,229,081 to Ura et al., which describes installing optical position detecting devices within a piano below the level of the keyboard. Typically, a piano manufacturer would need to install such a position detecting capability.

An approach that does not require modification of an acoustic piano is described in U.S. Pat. No. 4,768,412 to Sanderson. In this approach, a number of keyboard modules may be positioned such that each key of the keyboard is contacted by a piston having an end that rests upon the upper surface of the key. The piston is gravity operated and connects to a wiper assembly that blocks the path of light from a light emitting diode (LED) to a phototransistor when the piano key is in its “up” position. Movement of the piano key downwardly allows light to pass from the LED to the phototransistor. The patent states that each piston is connected to its wiper assembly by a mechanism that allows adjustment for higher or lower keys, depending upon the particular keyboard. While the installation is less demanding than with other prior art approaches, the use of the pistons in contact with the keys at one end and the wiper assemblies at the opposite end carries the potential of affecting the tactile and/or acoustic response of the piano.

### SUMMARY OF THE INVENTION

A device and method for use with a piano includes a housing that is configured to reside above only a small portion of a keyboard and includes a key-monitoring approach that remains free from mechanical contact with the keys of a keyboard. Different optical techniques are employed in acquiring data of the movement of white keys and acquiring data of the movement of black keys. In a preferred embodiment, position and velocity data relating to individual white keys is acquired by monitoring light reflected from the keys, while position and velocity data relating to the black keys is acquired by monitoring changes in light blocking characteristics.

The housing is located at the back region of the keyboard. The housing resides above the white keys, but may extend between adjacent black keys. However, neither the housing nor the means for monitoring the movement of the keys has an influence on such movement.

First light emitters are positioned to project light from the housing onto the white keys, while first photo receivers are positioned to detect the intensities of light reflected by the white keys. Each white key is operatively associated with at least one first light emitter and at least one first photo receiver. The photo receivers generate electrical outputs representative of the intensities of the reflected light.

Similarly, each black key is operatively associated with at least one second light emitter and at least one second photo receiver. The second photo emitters are positioned to project light from the housing onto black keys that are in rest positions. However, when a black key is lowered during use of the piano, the light from the second light emitter passes over the black key to the corresponding photo receiver or receivers. Thus, in contrast to a first photo receiver that generates an electrical signal representative of light after the light has impinged a white key, a second photo receiver generates an electrical signal representative of light which has not impinged a corresponding black key.

Computational processing is coupled to the first and second photo receivers and is enabled to determine position and velocity data for the white and black keys on the basis of the generated electrical signals. In a simplified embodiment, the information is limited to identification that specific keys have been moved, without regard to velocity.

In some applications, it may be beneficial to have more than one light emitter and/or photo receiver assigned to each key. As an alternative, the field of view for a single photo receiver can be increased by using an optical member such as a cylindrical lens.

In addition to monitoring movement of the keys of the piano, manipulation of the piano pedals may be monitored. As one possibility, a coil may be dedicated to each piano pedal and may be positioned such that its inductance is varied with displacement of the pedal. Optionally, wireless transmission may be used to transfer the signals to the computational processing.

As another optional feature, a flash detector may be used. The flash detector is configured to detect light flashes, such as from a photographic camera. It is possible that such flashes will adversely affect operations of the photo receivers in providing accurate information regarding key movements. Thus, as a response to detecting a flash, the data from the photo receivers may be momentarily inhibited.

One advantage of the invention is that the housing of the device is merely positioned above the back portion of the keyboard. Attachment may occur in less than one minute, since no modification of the piano is required. There is no mechanical contact with the keys or any other moving parts, thereby maintaining the tactile and acoustic response of the piano. Another advantage is that the device can be attached to virtually any piano, accommodating a variety of key spacings and mechanical characteristics. Moreover, there is minimal interference with a user's access to the keys of the keyboard, since the housing may occupy 10 millimeters or less of the rearmost portion of the keys.

### BRIEF DESCRIPTION OF THE DRAWINGS

FIG. 1 is a front view of a keyboard over which a non-intrusive key sensing device resides in accordance with one embodiment of the invention.

FIG. 2 is a side view of the device of FIG. 1, shown with a single black key and a single white key.

FIG. 3 is a front view of one embodiment of optical sensing used in the device of FIG. 1.

FIG. 4 is a front view of another embodiment of optical sensing in accordance with the invention.

FIG. 5 is a third embodiment of optical sensing in accordance with the invention.

FIG. 6 is a front view of a mechanically adaptive embodiment of the device of FIG. 1.

FIG. 7 is a schematic view of pedal motion sensing in accordance with the invention.

FIG. 8 is a schematic view of wireless transmission of piano pedal positioning in accordance with an embodiment of the invention.

FIG. 9 is a block diagram of system components which may be incorporated into and used with the device of FIG. 1.

### DETAILED DESCRIPTION

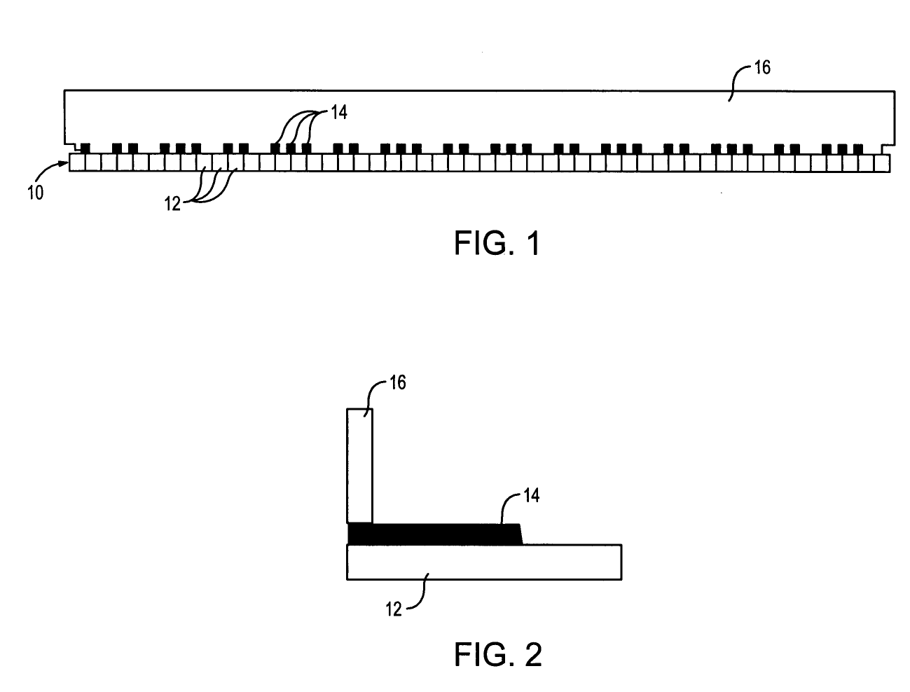

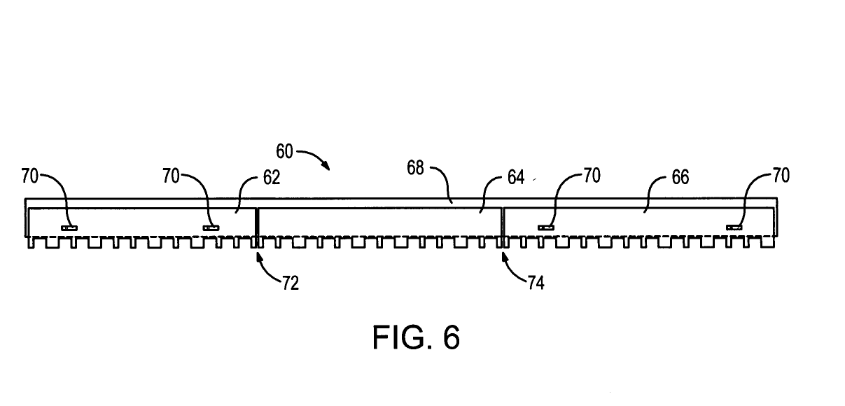

With reference to FIGS. 1 and 2, a conventional keyboard 10 having white keys 12 and black keys 14 is shown as being closely adjacent to a device 16 for monitoring the position and velocity of each manipulation of one of the keys 12 and 14. As can be seen in FIG. 2, the device 16 occupies only a small portion of the lengthwise direction of a key. Merely by example, the device may be 10 millimeters in width (corresponding to the lengthwise direction of the keys), 101.6 millimeters high, and 1.29 meters in length. However, the preferred embodiment is one in which the length is extendible to accommodate piano variations, as will be described below, when referring to FIG. 6. As shown in FIG. 1, the device 16 occupies the full length of the keyboard 10, so as to enable sensing of all 88 keys of the keyboard.

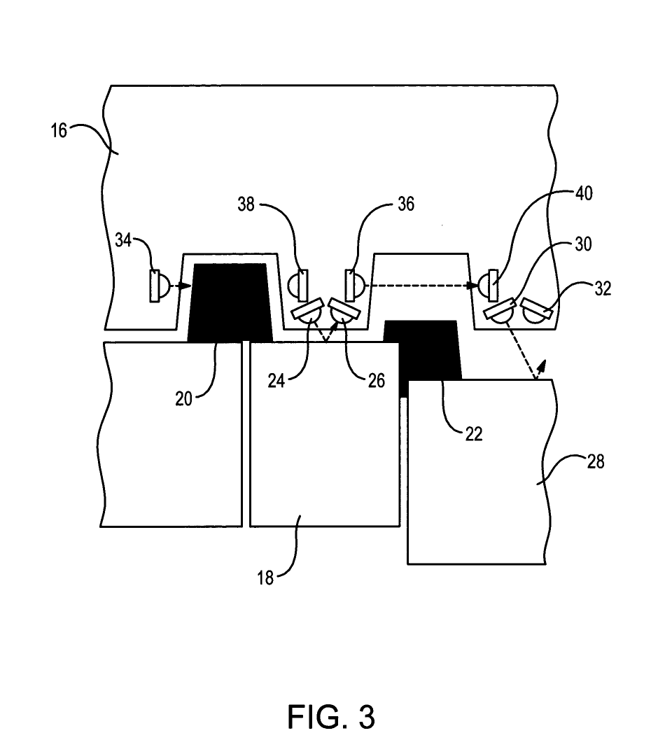

Optical techniques are employed to directly sense the position of the keys 12 and 14 of the keyboard 10. Ideally, there is no physical contact between the device 16 and the keys or with any other moving part of the piano for which the keyboard is a component. FIG. 3 illustrates one embodiment of the optical sensing. Two separate techniques are employed, with one technique being used to acquire position and velocity data for each white key 18 and a different approach being used to acquire position and velocity data for each black key 20 and 22. The white keys are highly reflective, as compared to the black keys. Therefore, reflected light is used as the basis for acquiring data relevant to movement of the white keys. A light emitting diode (LED) 24 or other light emitter directs light to impinge the top surface of the white key 18. A photosensor 26 is positioned to receive the reflected light from that top surface. The white key 18 is shown in its rest position, so that the optical coupling of the LED 24 and the photosensor 26 will be maximized. On the other hand, an adjacent white key 28 is shown in its fully depressed condition, so that optical coupling between an LED 30 and its corresponding photosensor 32 is minimized. Each photosensor generates an electrical output that is representative of the intensity of sensed reflected light.

The positions of the black keys 20 and 22 are more difficult to monitor using reflective techniques. Therefore, transmissive techniques are applied to sensing travel of the black keys. This is accomplished by placing LEDs 34 and 36 or other light emitting devices to project light which impinges the sides of the black keys. In FIG. 3, each LED 34 and 36 is aligned with a corresponding photosensor 38 and 40. The black key 20 is in its rest position, so that light from the LED 34 is blocked from reaching the corresponding photosensor 38. In comparison, the black key 22 is fully depressed, so that light from the LED 36 reaches the photosensor 40.

While the embodiment of FIG. 3 is well suited to acquire sufficient data to determine the positions of the white keys 18 and 28 and the black keys 20 and 22, the embodiment is limited with respect to acquiring velocity data for the black keys. More reliable information regarding the velocity of black keys can be acquired by increasing the field of view of the photosensing technique. The increase in the field of view allows the output signals to reflect a greater range of travel by the keys.

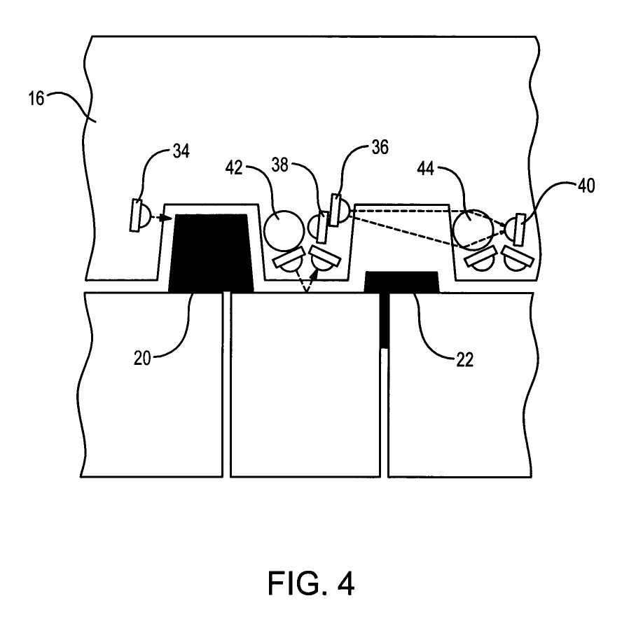

In FIG. 4, the increase in field of view is achieved by adding an optical member 42 and 44, such as a cylindrical lens, before each photosensor 38 and 40 for monitoring movement of the black keys 20 and 22. As in FIG. 3, the LEDs 34 and 36 are directed to project light onto the sides of the black keys when the keys are in their rest positions. However, as a black key is depressed, an increasing portion of light from the corresponding LED will reach the aligned photosensor. It follows that the strength of the electrical output signal from the photosensor will increase as a black key is moved downwardly and will decrease as the black key returns to its rest position.

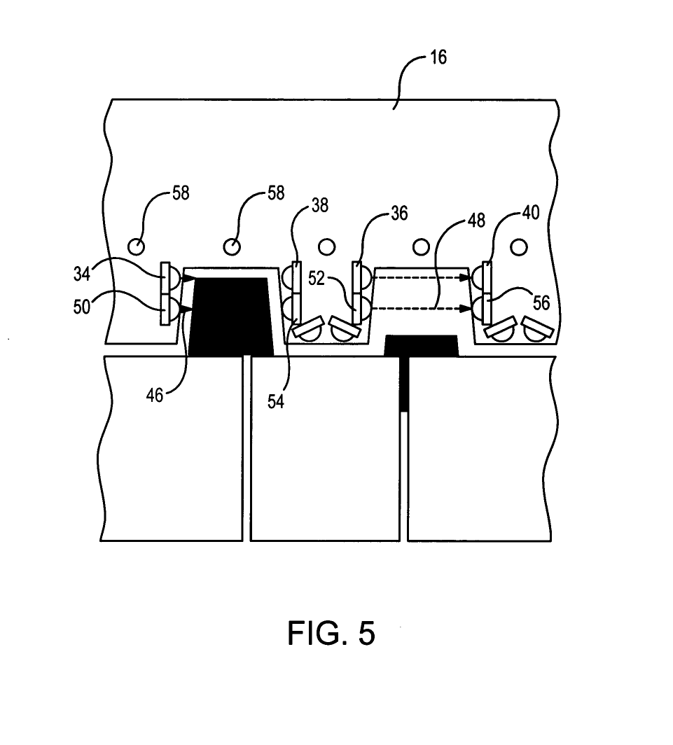

Referring now to the embodiment of FIG. 5, additional light beams 46 and 48 may be provided by LEDs 50 and 52 in order to increase the range of key travel that can be monitored. A corresponding number of photosensors 38, 40, 54 and 56 are aligned with the LEDs. However, the one-to-one correspondence between LEDs and photosensors is not critical, particularly if the beams from the LEDs are relatively high in intensity and are allowed to expand with distance from their sources. It has been determined that infrared beams 46 and 48 are beneficial with respect to detection, since the photosensors can be designed to detect light in the infrared range, reducing the susceptibility to error when a flash occurs, such as a camera flash. However, by incorporating a flash detector into the processing system, so that data from the photosensors is temporarily inhibited upon detecting a flash, other light emitters can be substituted without affecting performance.

Also shown in FIG. 5 is an array of LEDs 58 that are visible to a user of the piano in order to convey key-specific information to the user. By equipping the device 16 with an LED over each key, the device offers possibilities for interactive learning. The visible LEDs may be sequentially activated to display chords, modes, scales, finger manipulations and the like.

The spacing of piano keys varies among manufacturers and even varies among models from the same manufacturer. Preferably, the invention accommodates variations, so that the device can be attached to virtually any piano. Almost all standard pianos have octave lengths that fall within the range of 163.3 millimeters to 165.6 millimeters. A piano keyboard with a fixed octave spacing of the mean of this range (i.e., 164.5 millimeters) would have end photosensors displaced from key centers by 4.57 millimeters in a worst-case situation. If the required photosensing accuracy is 2.54 millimeters, it will be necessary to incorporate a means for varying the sensor spacing.

FIG. 6 shows one possible embodiment for enabling variability. The device 60 utilizes the two different sensing techniques described with reference to FIGS. 1-5, but the device is divided into several segments 62, 64 and 66 that are individually mounted to a frame member 68 that can be connected to a piano as a single-piece connection. The three segments work in tandem to span the entire keyboard, such as a conventional keyboard of 88 keys. In the embodiment of FIG. 6, the middle segment 64 is in a fixed position relative to the frame member, but the end segments 62 and 66 move horizontally to provide adjustability. Each end segment is locked into position on the frame member after the end segments have been adjusted horizontally on the basis of key spacings of a particular keyboard. For example, gap adjustment screws may be loosened and tightened within horizontally extending grooves 70 in order to vary one or both of the gaps 72 and 74 between the segments.

While three segments 62, 64 and 66 are shown in FIG. 6, the number is not critical. However, an increase in the number of segments provides an increase in the ability of the device 60 to accommodate differences in the key spacings of different keyboards with which the device may be used.

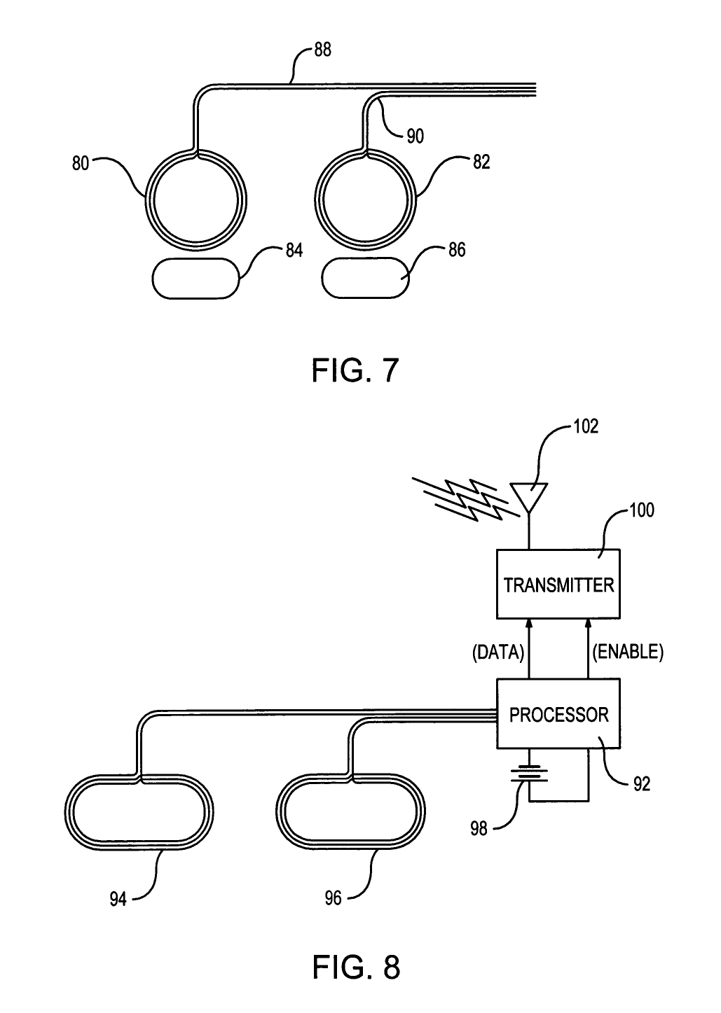

As another feature of the invention, the positions of piano pedals (soft and sustain) are sensed. In FIG. 7, two coils 80 and 82, each having a diameter of approximately 50 millimeters, are placed adjacent to piano pedals 84 and 86. While the piano pedals are shown as being located below the coils, it is more likely that the positions will be reversed. In this embodiment, signals from the coils are conducted to a signal processing capability (such as a controller) by cables 88 and 90. Displacement of the pedals 84 and 86 causes the inductance of the coils to change, so that the output signals are indicative of changes in inductance. The changes can be measured by appropriate signal processing and, optionally, can be converted to MIDI signals.

Another embodiment of pedal sensing is shown in FIG. 8. In this embodiment, the pedal sensing combines the coil assembly with its processing circuitry 92. The coils 94 and 96 are shown as being widened in order to accommodate variations in pedal spacing. Pedal movement events are recognized by the processor 92 by monitoring the inductance of the coils and are transmitted via a wireless link to a main control box (not shown). This eliminates the necessity of locating an interconnecting cable from the coils to the processing circuitry.

A battery 98 provides the power for operating the processor 92 and a transmitter 100. To ensure long life of the battery, the duration of the transmission is minimized. An acceptable duration is 5 milliseconds. When a significant event is detected (i.e., pedal up or pedal down), the transmitter 100 is enabled by the processor. An internal antenna 102 may be used to radiate signals to the main control capability. The entire assembly may be housed in a flat rectangular box that is placed under the piano pedals. Calibration is automatic and, with no cables, stability is ensured.

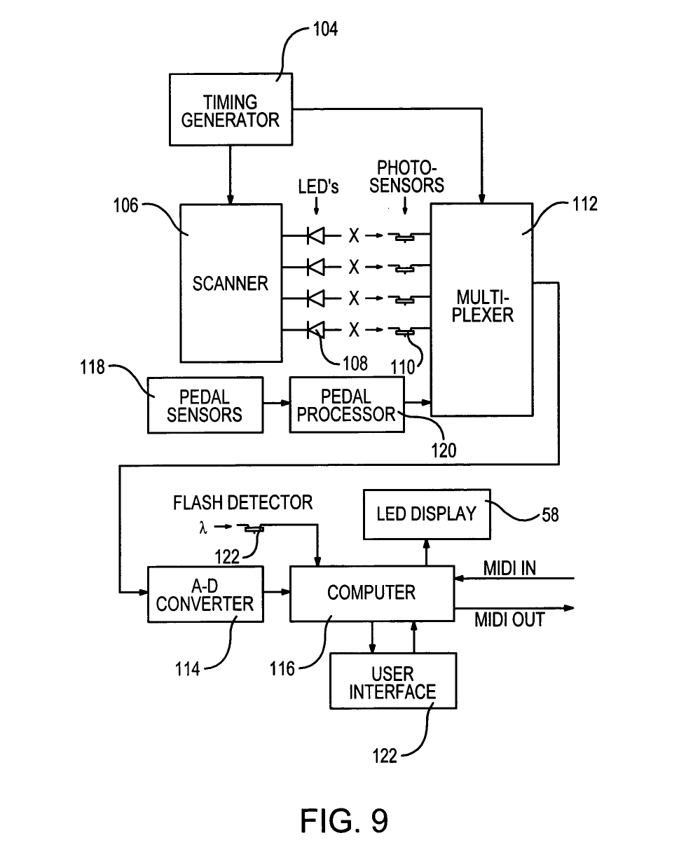

FIG. 9 is a logic diagram of the system. A timing generator 104 drives a scanner 106, which sequentially turns the various LEDs 108 “on.” As previously noted, each key of the piano is associated with at least one LED. Simultaneously, the photosensors 110 are sequentially scanned by a multiplexer 112. The output currents of the photosensors are converted to digital signals by an analog-to-digital converter 114 for processing by a computer 116. Additionally, the outputs of the pedal sensors 118 are conditioned by the pedal processor 120 and are multiplexed into the signal chain to the computer 116. While the computer is shown as having wired connections (such as a cable) in order to receive signals from the photosensors and the pedal sensors, wireless transmissions of signals from either or both of the photosensors and the pedal sensors may be substituted without diverging from the invention.

The computer 116 operates under a set program, but instructions may be provided by a user via a user interface 122. The user interface may be a keyboard, a computer mouse, or any other known device. The programming of the computer may provide MIDI compatibility, so that appropriate signals may be transmitted to an external apparatus or may be received from external devices, including synthesizers, sequencers, and samplers. A flash detector 124 signals the computer 116 when an external flash of light occurs, so that the flash is less likely to interfere with proper operations. As one possibility, the computer may respond to the identification of a flash by momentarily inhibiting data from the photosensors 110.

To enhance the usefulness and capabilities of the system of FIG. 9, the computer may respond to externally applied MIDI signals, so as to sequence the LEDs 58 which were previously described with reference to FIG. 5. The sequencing may be used to provide a teaching capability or may be used for other applications. The computer 116 decodes the MIDI signals and activates the LEDs associated with the appropriate keys.

What is claimed is:

1. A device for use with a piano comprising:
a housing configured to reside above a minor portion of a keyboard of said piano, said housing being dimensioned to be non-intrusive with respect to manipulations of said keyboard by a user of said piano; and
an array of signal generators mounted to said housing to monitor activities of a plurality of keys of said keyboard, each said signal generator being operatively associated with one of said keys and including at least one light emitting device positioned to direct light so as to directly impinge said associated key when said associated key is in a rest position, each said signal generator further including at least one optical receiver positioned with respect to said associated key and said light emitting device of said each signal generator to detect movement of said associated key relative to said rest position;
wherein said keys remain free from mechanical contact with structure for enabling said signal generators to monitor said activities of said keys.

2. The device of claim 1 wherein said array includes first signal generators dedicated to white keys of said keyboard and includes second signal generators dedicated to black keys of said keyboard, wherein:
(a) said at least one light emitting device and said at least one optical receiver of each said first signal generator are cooperative to provide an output signal that is indicative of intensity of light reflected from said white key to which said first signal generator is dedicated; and
(b) said at least one light emitting device and said at least one optical receiver of each said second signal generator are cooperative to provide an output signal that is indicative of light blocked by said black key to which said second signal generator is dedicated.

3. The device of claim 2 wherein each said second signal generator includes an optical member cooperative with said at least one optical receiver to provide an expanded field of view for detecting light from said at least one light emitting device.

4. The device of claim 3 wherein said optical member is a cylindrical lens, said at least one light emitting device being a single light emitting diode (LED).

5. The device of claim 2 wherein each said second signal generator includes a plurality of said light emitting devices and a plurality of said optical receivers.

6. The device of claim 1 further comprising means for sensing positions of pedals of said piano and generating electrical signals indicative of displacements of said pedals.

7. The device of claim 6 wherein said means for sensing includes coils having a one-to-one correspondence with said pedals, said coils being positioned relative to said pedals to have inductances which vary with said displacements of said pedals.

8. The device of claim 7 wherein said means for sensing further includes a wireless transmitter enabled to transmit said electrical signals that are indicative of displacements of said pedals.

9. The device of claim 1 further comprising computer processing connected to receive output signals from said array of signal generators and to calculate velocity data for displacements of each said key, said velocity data being based upon sequencing within said output signals.

10. The device of claim 1 further comprising a flash detector configured to detect light flashes in an area of said piano and to momentarily inhibit data from said signal generators as a response thereto.

11. A device for use with a piano comprising:
a housing located at a back region of a keyboard of said piano so as to be adjacent to a plurality of white keys and to extend between black keys without influencing movement of said white and black keys when said keyboard is in use;
a set of first light emitters disposed to project light from said housing onto said white keys;
a set of first photo receivers positioned to detect portions of said light reflected by said white keys, said first photo receivers being enabled to generate electrical outputs representative of intensities of said detected portions of light;
a set of second light emitters disposed to project light from said housing onto said black keys when said black keys are at rest, while allowing said light to pass above said black keys when said black keys are lowered;
a set of second photo receivers positioned to detect said light passing above said black keys, said second photo receivers being enabled to generate electrical outputs representative of intensities of said light; and
computational processing coupled to said first and second photo receivers to receive said electrical outputs, said computational processing being enabled to determine position and velocity data for said white and black keys on a basis of said electrical outputs.

12. The device of claim 11 further comprising piano pedal sensors located to generate position information that is specific to pedals of said piano, said computational processing being configured to form signals compatible with an external apparatus using a Musical Instrument Digital Interface (MIDI) format.

13. The device of claim 11 further comprising indicators assigned to said white and black keys, said indicators being connected to said housing to be visible by a user of said piano, said computational processing being configured to transmit signals to said indicators in predetermined sequences for prompting said using in manipulating said white and black keys.

14. A method of non-intrusively detecting manipulations of a keyboard comprising:
monitoring reflected light which is reflected by individual white keys of said keyboard in order to distinguish times in which said white keys are at rest from times in which said white keys are displaced;
monitoring unblocked light which is unblocked by individual black keys of said keyboard in order to distinguish times in which said black keys are at rest from times in which said black keys are displaced; and
determining position and velocity data for said individual white and black keys on a basis of variations in intensities of said reflected and unblocked light.

15. The method of claim 14 wherein, for each said white key, monitoring said reflected light includes projecting a first light beam to impinge said white key and generating a signal indicative of a portion of said first light beam reflected by said white key.

16. The method of claim 15 wherein, for each said black key, monitoring said unblocked light includes projecting a second light beam to impinge said black key when said black key is in a rest position and generating a signal indicative of a portion of said second light beam which propagates to at least one aligned photo receiver.

17. The method of claim 16 wherein monitoring said unblocked light further includes assigning a plurality of said aligned photo receivers to each said black key, so as to provide a wider field of view in generating said signal.

18. The method of claim 14 further comprising using electronic monitoring to sense mechanical manipulations of pedals of said piano, said steps of monitoring and electronic monitoring being executed without mechanically affecting said pedals and said white and black keys.

19. The method of claim 18 wherein using electronic monitoring to sense said mechanical manipulations includes positioning a coil adjacent to each said pedal and sensing inductances of said coils.

20. The method of claim 19 wherein said steps of electronic monitoring and determining position and velocity data contribute to generating MIDI-compatible signals representative of movements of said pedals and said white and black keys.
